(19) United States
(12) Patent Application Publication
(10) Pub. No.: US 2006/0218050 A1
(43) Pub. Date: Sep. 28, 2006

(54) METHOD AND APPARATUS FOR FACILITATING ELECTRONIC COMMERCE THROUGH PROVIDING CROSS-BENEFITS DURING A TRANSACTION

(76) Inventors: Jay S. Walker, Ridgefield, CT (US); Daniel E. Tedesco, New Canaan, CT (US); John M. Packes JR., Stamford, CT (US); James A. Jorasch, Stamford, CT (US)

Correspondence Address: WALKER DIGITAL, 2 HIGH RIDGE PARK, STAMFORD, CT, 06905, US

(21) Appl. No.: 11/423,498

(22) Filed: Jun. 12, 2006

Related U.S. Application Data
(63) Continuation of application No. 09/219,267, filed on Dec. 23, 1998.
Application No. 09/219,267 is a continuation of application No. 08/943,483, filed on Oct. 3, 1997, now abandoned.
Application No. 08/943,483 is a continuation-in-part of application No. 08/923,683, filed on Sep. 4, 1997, now Pat. No. 6,553,346.
Application No. 08/923,683 is a continuation-in-part of application No. 08/889,319, filed on Jul. 8, 1997, now Pat. No. 6,085,169.
Application No. 08/889,319 is a continuation-in-part of application No. 08/707,660, filed on Sep. 4, 1996, now Pat. No. 5,794,207.

(51) Int. Cl. G06Q 30/00

(52) U.S. Cl. 705/26

(57) ABSTRACT

A merchant server of a first merchant receives an indication of items that a customer is to purchase via a web site. The indication may be, for example, a signal indicating that the customer is ready to “check out” his shopping cart of items on the web site. In response, the merchant server provides an offer for a subsidy from a second merchant. The offer is provided before the items are purchased, and thus the offer is not provided unless and until the customer has manifested an intent to make a purchase from the first merchant. A response is received from the customer. If the response indicates acceptance of the offer, then the subsidy is applied to the items purchased. For example, the total price paid for the items may be reduced, or the items may even be provided to the customer without charge. In exchange, the customer agrees to participate in a transaction with the second merchant. For example, the customer may be required to switch service providers (e.g. long distance telephone service) or initiate a new service agreement (e.g. sign up for a credit card account).

The present application is a continuation-in-part application of co-pending U.S. patent application Ser. No. 08/943,483 entitled “SYSTEM AND METHOD FOR FACILITATING ACCEPTANCE OF CONDITIONAL PURCHASE OFFERS (CPOs)” to Andrew S. Van Luchene, Daniel E. Tedesco, James A. Jorasch, Jay S. Walker and Thomas M. Sparico filed on Oct. 3, 1997, which is a continuation-in-part of co-pending U.S. patent application Ser. No. 08/923,683 entitled “CONDITIONAL PURCHASE OFFER (CPO) MANAGEMENT SYSTEM FOR PACKAGES” to Andrew S. Van Luchene, Daniel E. Tedesco, James A. Jorasch, Jay S. Walker and T. Scott Case filed Sep. 4, 1997, which is a continuation-in-part of U.S. patent application Ser. No. 08/889,319 entitled “CONDITIONAL PURCHASE OFFER MANAGEMENT SYSTEM” to Bruce Schneier, James A. Jorasch, Jay S. Walker and T. Scott Case filed Jul. 8, 1997, which is a continuation-in-part of U.S. Pat. No. 5,794,207 entitled “METHOD AND APPARATUS FOR A CRYPTOGRAPHICALLY ASSISTED COMMERCIAL NETWORK SYSTEM DESIGNED TO FACILITATE BUYER-DRIVEN CONDITIONAL PURCHASE OFFERS” issued to Bruce Schneier, James A. Jorasch and Jay S. Walker on Aug. 11, 1998; and a continuation-in-part of co-pending U.S. patent application Ser. No. 09/100,684 entitled “BILLING STATEMENT CUSTOMER ACQUISITION SYSTEM” to Daniel E. Tedesco, James A. Jorasch and Jay S. Walker filed on Jun. 19, 1998, which is a continuation-in-part of co-pending U.S. patent application Ser. No. 08/982,149 entitled “METHOD AND APPARATUS FOR PRINTING A BILLING STATEMENT TO PROVIDE SUPPLEMENTARY PRODUCT SALES” to Jay S. Walker, Daniel E. Tedesco, Andrew S. Van Luchene and Dean P. Alderucci filed on Dec. 1, 1997; and a continuation-in-part of co-pending U.S. patent application Ser. No. 08/994,426 entitled: METHOD AND APPARATUS FOR PROVIDING SUPPLEMENTARY PRODUCT SALES TO A CUSTOMER AT A CUSTOMER TERMINAL” to Jay S. Walker, Andrew S. Van Luchene and Daniel E. Tedesco filed on Dec. 19, 1997, which is a continuation-in-part of co-pending U.S. patent application Ser. No. 08/920,116 entitled “METHOD AND SYSTEM FOR PROCESSING SUPPLEMENTARY PRODUCT SALES AT A POINT-OF-SALE TERMINAL” to Jay S. Walker, James A. Jorasch and Andrew S. Van Luchene filed on Aug. 26, 1997, which is a continuation-in-part of co-pending U.S. patent application Ser. No. 08/822,709 entitled “SYSTEM AND METHOD FOR PERFORMING LOTTERY TICKET TRANSACTIONS UTILIZING POINT-OF0SALE TERMINALS” to Jay S. Walker, James A. Jorasch and Sanjay K. Jindal, each of the foregoing applications incorporated herein by reference.

### FIELD OF THE INVENTION

The present invention relates to methods and apparatus for facilitating electronic commerce.

### BACKGROUND OF THE INVENTION

Electronic commerce is becoming more accepted as growing numbers of customers find shopping via the World Wide Web more appealing. However, electronic commerce suffers many problems that have plagued conventional commerce. For example, there is a great deal of competition among merchants to attract and retain customers that actually make purchases. Price competition is even stronger on the Internet, where customers can more readily “shop around” and determine the prices offered by various merchants.

Even when a customer has browsed a merchant's inventory, he may not make a purchase if an item's price is greater than the customer is willing to pay. One way to increase customer willingness to purchase, via the World Wide Web or otherwise, is to provide discounts on items purchased. Unfortunately, merchants must use discounts sparingly, since reducing purchase prices likewise reduces profits and the reduced profits may not be offset by increased sales.

It is known for a merchant to offer promotions to provide an incentive for customers to make purchases. For example, a merchant may offer a “buy one get one free” promotion whereby a purchase of an item yields the benefit of an additional item at no cost. Similarly, a merchant may provide a discount on a purchase in exchange for signing up for a credit card account provided by the merchant.

It is known to provide a promotion among more than one merchant. For example, a first merchant may advertise that if a product is purchased, a second product may be purchased from or given away by a second merchant.

It is also known for a promotion to be provided at the point of sale. For example, a web site of a merchant may provide a “banner advertisement” that allows a customer to go to another site to make a second purchase.

It would be advantageous to facilitate further electronic commerce in a manner that maintained an acceptable level of profits for merchants yet increased a customer's willingness to make purchases.

### SUMMARY OF THE INVENTION

It is an object of the present invention to facilitate electronic commerce.

In accordance with the present invention, a merchant server of a first merchant receives an indication of items that a customer is to purchase via a web site. The indication may be, for example, a signal indicating that the customer is ready to “check out” his shopping cart of items on the web site. In response, the merchant server provides an offer for a benefit from a second merchant, which may be referred to as a cross-benefit. The offer is provided before the items are purchased, and thus the offer is not provided unless and until the customer has manifested an intent to make a purchase from the first merchant. A response to the offer is received from the customer. If the response indicates acceptance of the offer, then the benefit is applied to the items purchased. For example, the total price paid for the items may be reduced, or the items may even be provided to the customer without charge.

In exchange, the customer agrees to participate in a transaction with the second merchant. For example, the customer may be required to switch service providers (e.g. long distance telephone service) or initiate a new service agreement (e.g. sign up for a credit card account). In one embodiment, the customer's agreement may be secured, such that a penalty is assessed against the customer if he does not participate in the transaction as he agreed to.

### BRIEF DESCRIPTION OF THE DRAWINGS

FIG. 1 is a schematic illustration of an apparatus for facilitating electronic commerce.

FIG. 2 is a schematic illustration of a merchant server of the apparatus of FIG.

FIG. 3 is a representation of a customer database of the merchant server of FIG. 2.

FIG. 4 is a representation of an item database of the merchant server of FIG. 2.

FIG. 5 is a representation of a transaction database of the merchant server of FIG. 2.

FIG. 6 is a representation of a subsidizer database of the merchant server of FIG. 2.

FIG. 7 is a representation of an offer rules database of the merchant server of FIG. 2.

FIG. 8 is a representation of an offers database of the merchant server of FIG. 2.

FIG. 9 is a representation of a record of an offer summary database of the merchant server of FIG. 2.

FIG. 10 is a flow chart illustrating an embodiment of a method for providing an offer for a benefit to a customer that is to purchase items from a merchant.

FIG. 11 is an exemplary web page.

FIG. 12 is another exemplary web page.

FIGS. 13A and 13B are a flow chart illustrating another embodiment of a method for providing an offer for a benefit to a customer that is to purchase items from a merchant.

FIGS. 14A and 14B are a flow chart illustrating another embodiment of a method for providing an offer for a benefit to a customer that is to purchase items from a merchant.

FIG. 15 is a flow chart illustrating another embodiment of a method for providing an offer for a benefit to a customer that is to purchase items from a merchant.

FIG. 16 is a flow chart illustrating another embodiment of a method for providing an offer for a benefit to a customer that is to purchase items from a merchant.

### DETAILED DESCRIPTION OF THE PREFERRED EMBODIMENTS

Applicants have recognized that the acquisition budgets of various service providers may be advantageously used to facilitate electronic commerce. A customer that is purchasing items from a first merchant may be paid by a second merchant, so that the customer pays a reduced price, or nothing at all, for his desired items. In exchange, the customer signs up or agrees to sign up for a service that is provided by the second merchant. Since many service providers are willing to pay significant amounts of money (e.g. often $50 to $200) to acquire a new customer, the ability to acquire a customer by essentially “intervening” in a sale between others can benefit all parties involved. The customer is benefited by the reduced price of his items, the first merchant is benefited by the increased sales that such an arrangement would bring, and the second merchant is benefited by the acquisition of a new customer.

Furthermore, by presenting offers for such “cross-subsidies” only after a customer is ready to buy items, the merchant may reduce the chance that customers will merely “bargain shop”, rather than make purchases.

In addition, a number of benefits may be offered besides reduced prices. For example, the first merchant may alternatively provide the customer with an upsell (e.g. a product upgrade for no additional cost).

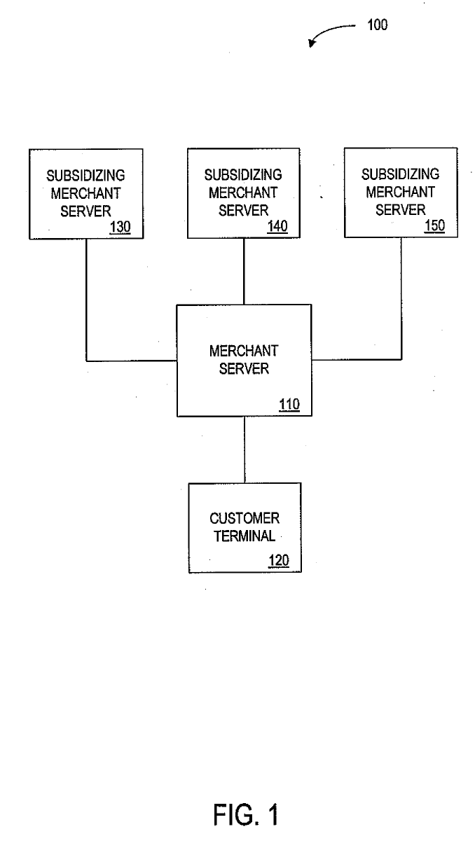

Referring to FIG. 1, an apparatus 100 includes a merchant server 110 that is in communication with a customer terminal 120 and with subsidizing merchant servers 130, 140 and 150. The merchant server 110 may communicate with the customer terminal 120 and subsidizing merchant servers 130, 140 and 150 via an appropriate network such as the Internet. Each of the customer terminal 120 and with subsidizing merchant servers 130, 140 and 150 may comprise computers, such as those based on the Intel® Pentium® microprocessor, that are adapted to communicate via the Internet (e.g. via a modem). Any number of subsidizing merchant servers and customer terminals may be in communication with the merchant server 110.

The merchant server 110 may be a “web server” of a merchant. The merchant server 110 can generate a web page that may be accessed via the World Wide Web and allow purchases from the merchant to be made in a manner known in the art. A customer terminal may appropriately access the web page to communicate with the merchant server 110 in a manner that is also known to those skilled in the art.

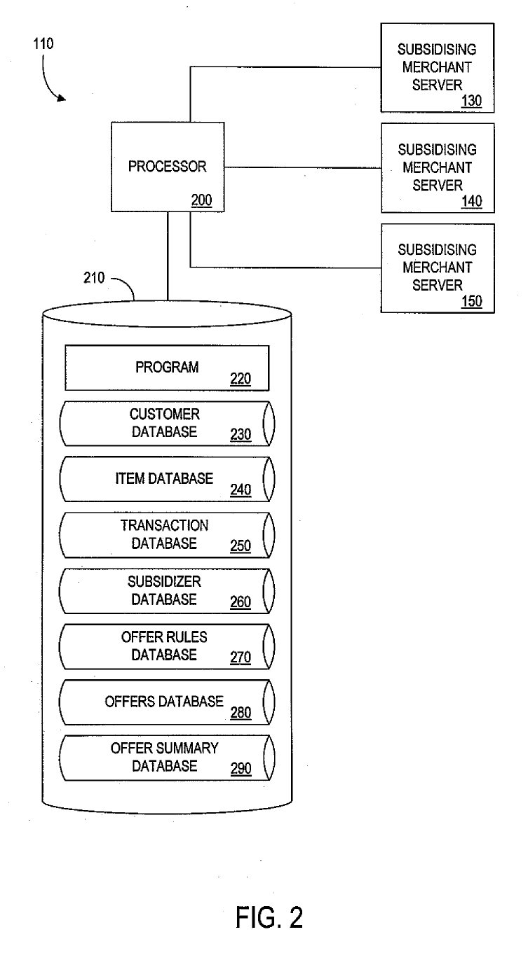

Referring to FIG. 2, the merchant server 110 comprises a processor 200, such as the Intel® Pentium® microprocessor. The processor 200 is in communication with a data storage device 210, such as an appropriate combination of magnetic, optical and/or semiconductor memory. For example, the data storage device 210 may comprise one or more of a ROM, RAM and hard disk. The processor 200 and the data storage device 210 may each be (i) located entirely within a single computer or other computing device; (ii) connected to each other by a remote communication medium, such as a serial port cable, telephone line or radio frequency transceiver; or (iii) a combination thereof. In one embodiment, the merchant server 110 may comprise one or more computers that are connected to a remote server computer for maintaining databases.

The data storage device 210 stores a program 220 for controlling the processor 200. The processor 200 performs instructions of the program 220, and thereby operates in accordance with the present invention, and particularly in accordance with the methods described in detail herein. The program 220 furthermore includes program elements that may be necessary, such as an operating system and “device drivers” for allowing the processor 200 to interface with computer peripheral devices. Appropriate device drivers and other necessary program elements are known to those skilled in the art, and need not be described in detail herein.

The storage device 210 also stores (i) a customer database 230, (ii) a item database 240, (iii) a transaction database 250, (iv) a subsidizer database 260, (v) an offer rules database 270, (vi) an offers database 280 and (vii) an offer summary database 290. The databases 230, 240, 250, 260, 270, 280 and 290 are described in detail below and depicted with exemplary entries in the accompanying figures. As will be understood by those skilled in the art, the schematic illustrations and accompanying descriptions of the databases presented herein are exemplary arrangements for stored representations of information. A number of other arrangements may be employed besides those suggested by the tables shown.

Similarly, the illustrated entries of the databases represent exemplary information, and those skilled in the art will understand that the number and content of the entries can be different from those illustrated herein.

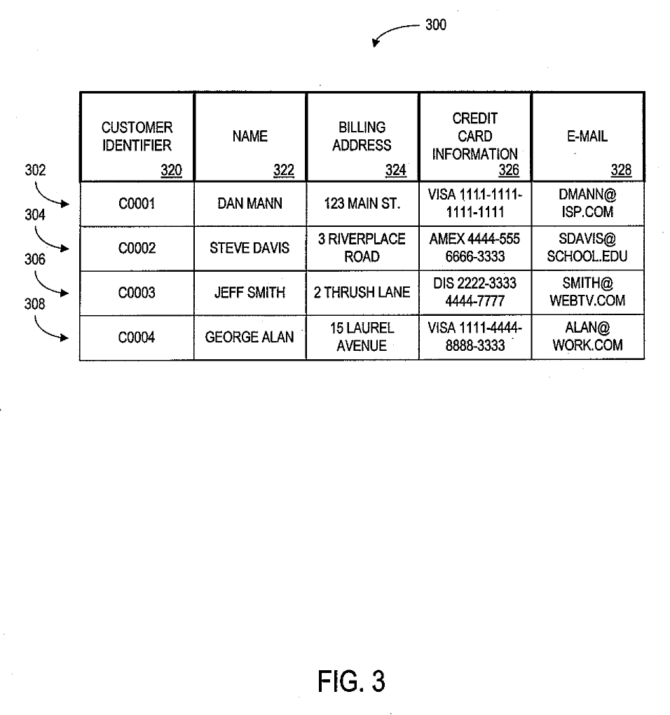

Referring to FIG. 3, a table 300 represents an embodiment of the customer database 230 (FIG. 2). The table 300 includes entries 302, 304, 306 and 308, each defining a customer that may purchase items via the merchant server 110 (FIG. 1). Those skilled in the art will understand that the table 300 may include any number of entries. The table 300 also defines fields for each of the entries 302, 304, 306 and 308. The fields specify (i) a customer identifier 320 that uniquely identifies the customer, (ii) a name 322 of the customer, (iii) a billing address 324 of the customer, (iv) credit card information 326 which may be used to render payment in purchasing the items, and (v) an electronic mail (“email”) address 328 for communication with the customer.

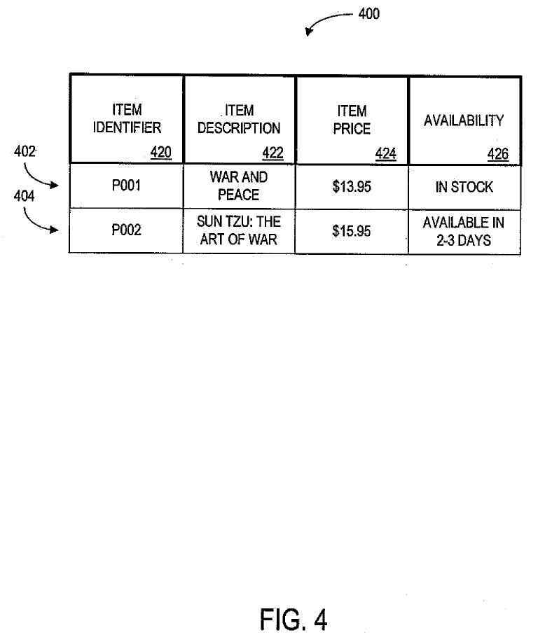

Referring to FIG. 4, a table 400 represents an embodiment of the item database 240 (FIG. 2). The table 400 includes entries 402 and 404, each defining an item sold via the merchant server 10 (FIG. 1). Those skilled in the art will understand that the table 400 may include any number of entries. The table 400 also defines fields for each of the entries 402 and 404. The fields specify (i) a item identifier 420 that uniquely identifies the item, (ii) an item description 422, (iii) an item price 424 for which the item is typically sold, and (iv) an availability 426 of the item which may be based on an inventory level of the item.

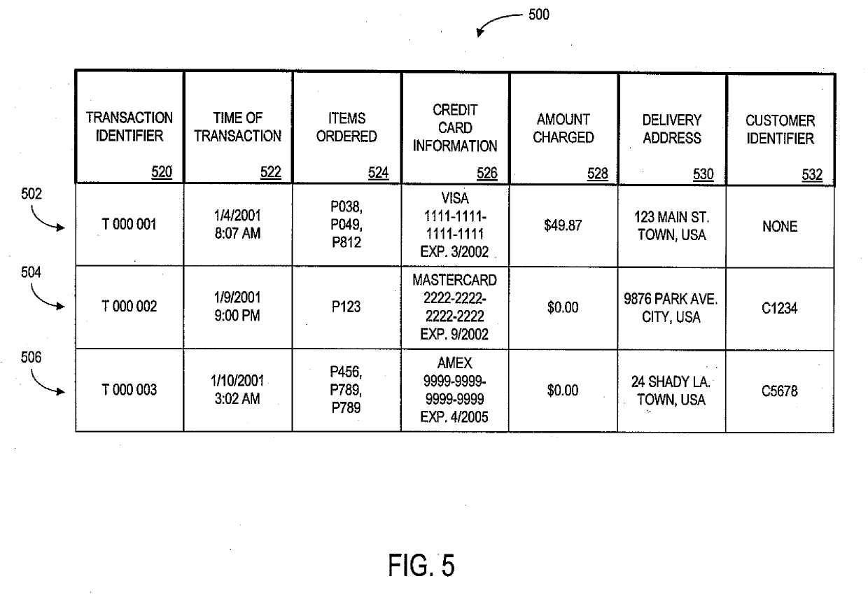

Referring to FIG. 5, a table 500 represents an embodiment of the transaction database 250 (FIG. 2). The table 500 includes entries 502, 504 and 506, each defining a transaction with the merchant server 110 (FIG. 1). Typically, the transaction includes a purchase of items by a customer. Those skilled in the art will understand that the table 500 may include any number of entries. The table 500 also defines fields for each of the entries 502, 504 and 506. The fields specify (i) a transaction identifier 520 that uniquely identifies the transaction, (ii) a time 522 of the transaction, (iii) the items ordered 524, (iv) credit card information 526 that may define a credit card account that was charged to pay for the items purchased, (v) an amount charged 528 for the items, (vi) a delivery address 530 for the items, and (vii) a customer identifier 532 (if any) that identifies the customer that made the purchase.

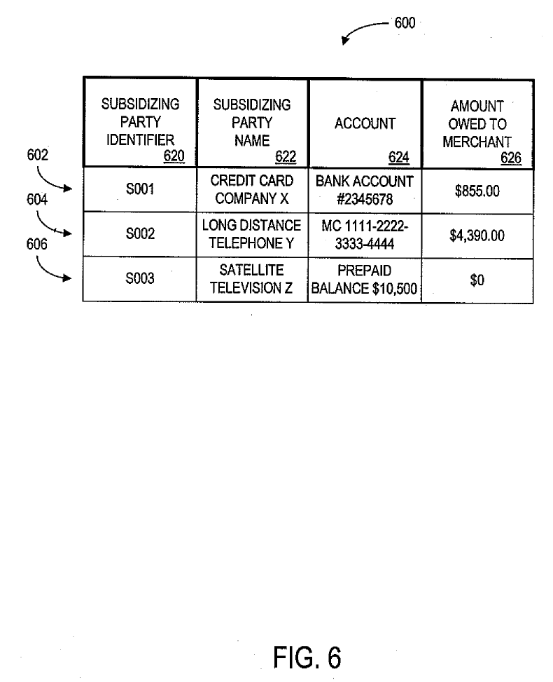

Referring to FIG. 6, a table 600 represents an embodiment of the subsidizer database 260 (FIG. 2). The table 600 includes entries 602, 604 and 606, each defining a party (e.g. another merchant) that may subsidize purchases made via the merchant server 110 (FIG. 1). Those skilled in the art will understand that the table 600 may include any number of entries. The table 600 also defines fields for each of the entries 602, 604 and 606. The fields specify (i) a subsidizing party identifier 620 that uniquely identifies the subsidizing party, (ii) a name 622 of the subsidizing party, (iii) an account 624 used to pay for the subsidies, and (iv) an amount owed 626 by the subsidizing party to the merchant.

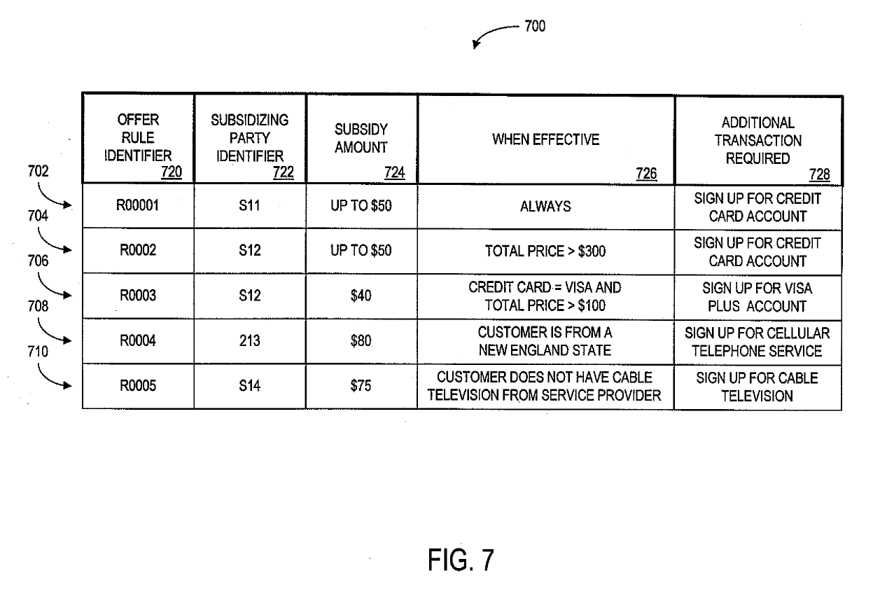

Referring to FIG. 7, a table 700 represents an embodiment of the offer rules database 270 (FIG. 2). The table 700 includes entries 702, 704, 706, 708 and 710, each defining an offer rule. When an offer rule is satisfied during a transaction, the merchant provides an offer for a specified benefit, such as a subsidy. Those skilled in the art will understand that the table 700 may include any number of entries. The table 700 also defines fields for each of the entries 702, 704, 706, 708 and 710. The fields specify (i) an offer rule identifier 720 that uniquely identifies the offer rule, (ii) a subsidizing party identifier 722 that uniquely identifies the subsidizing party, (iii) a subsidy amount 724, (iv) when the offer rule is effective (i.e. when the offer rule is satisfied), and (v) an additional transaction 728 that is required of the customer in exchange for the subsidy. As described below, several types of transactions, such as additional purchases or initiating service agreements, may be required of the customer.

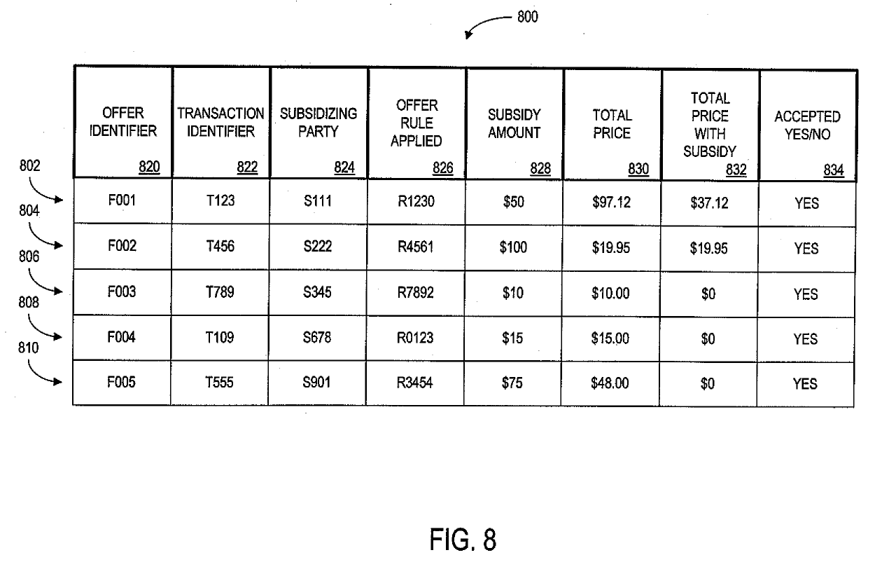

Referring to FIG. 8, a table 800 represents an embodiment of the offers database 280 (FIG. 2). The table 800 includes entries 802, 804, 806, 808 and 810, each defining an offer for a subsidy. The offer was provided to a customer during a transaction of the customer with the merchant. Those skilled in the art will understand that the table 800 may include any number of entries. The table 800 also defines fields for each of the entries 802, 804, 806, 808 and 810. The fields specify (i) an offer identifier 820 that uniquely identifies the offer, (ii) a transaction identifier 822 that uniquely identifies the transaction during which the offer was provided, (iii) a subsidizing party identifier 824 that uniquely identifies the subsidizing party, (iv) an identifier of an offer rule 826 that was satisfied during the transaction, (v) a subsidy amount 828, (vi) a total price 830 that the customer would have to pay without the subsidy, (vii) a total price 832 that the customer would have to pay with the subsidy, and (viii) whether the offer was accepted 834. As described above with reference to FIG. 7, offer rules define specific subsidies. Thus, the identifier of an offer rule stored in field 826 may be used to determine a corresponding subsidy amount.

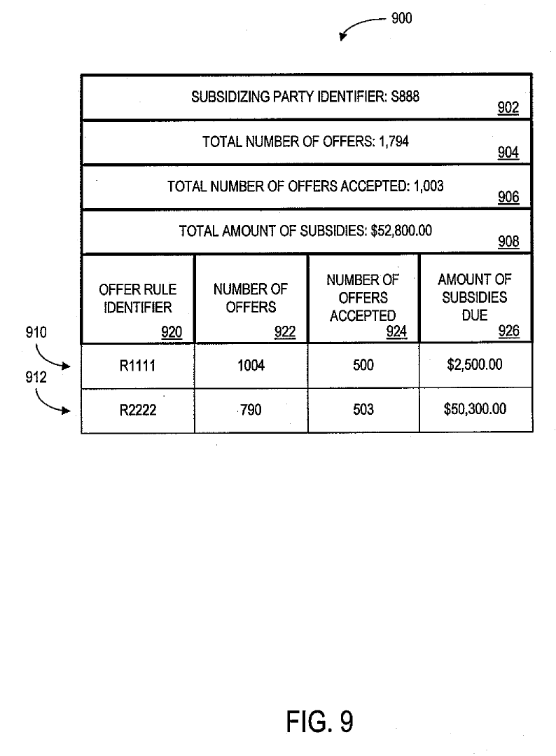

Referring to FIG. 9, a table 900 represents a record of an embodiment of the offer summary database 290 (FIG. 2). The offer summary database 290 typically includes a plurality of records, each defining a summary of offers for subsidies that have been provided on behalf of a subsidizing party. The table 900 includes a subsidizing party identifier 902 that uniquely identifies the subsidizing party, a total number of offers provided 904 on behalf of the subsidizing party, a total number of those offers that were accepted 906, and a total amount 908 of the subsidies due in connection with accepted offers.

The table 900 also includes entries 910 and 912, each defining offers provided due to satisfaction of an offer rule of the subsidizing party. Those skilled in the art will understand that the table 900 may include any number of entries. The table 900 also defines fields for each of the entries 910 and 912. The fields specify (i) an offer rule identifier 920 that uniquely identifies the offer rule, (ii) a number 922 of offers provided due to the offer rule, (iii) a number 924 of these offers that were accepted, (iv) an amount 926 of the subsidies due in connection with these accepted offers.

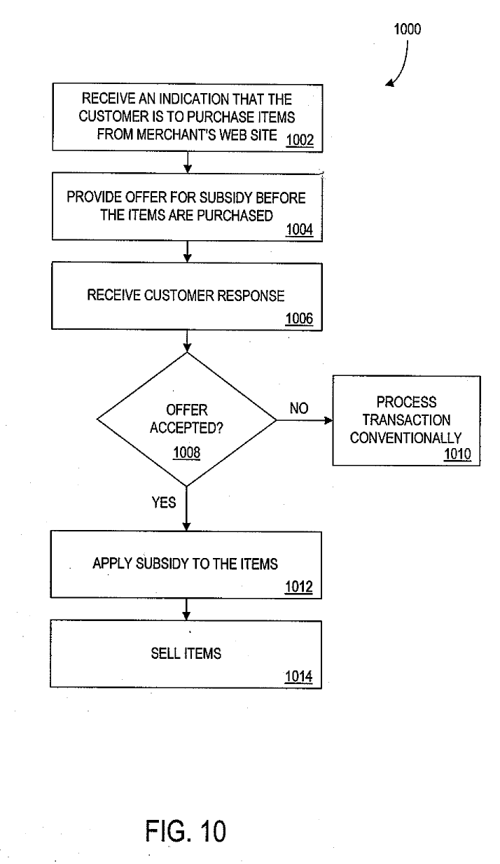

Referring to FIG. 10, a flow chart 1000 illustrates an embodiment of a method for providing an offer for a benefit to a customer that is to purchase items from a merchant. In one embodiment, the illustrated method is performed by the merchant server 110 after the customer has accessed a web page generated and/or controlled by the merchant server 110.

The merchant server 110 receives an indication that the customer is to purchase items from the web site of the merchant (step 1002). For example, after a customer accesses the web site, the customer may select one or more items to purchase, and “click” a button that indicates that the customer desires to purchase the selected items. The act of clicking could generate a signal that the merchant server 110 interprets as an indication that the customer is to purchase the selected items. In another embodiment, the act of accessing the web site could generate a signal that the merchant server 110 interprets as an indication that the customer is to purchase the selected items. Those skilled in the art will understand still other types of appropriate indications.

Before the customer purchases the items, the merchant server 110 provides the customer with an offer for a subsidy (step 1004). For example, the web page may display text describing the subsidy. In one embodiment, the web page may be dynamically modified to include a button that, when clicked, indicates acceptance of an offer for a subsidy. Alternatively, the offer may be transmitted to the customer via email or other means.

A response to the offer is received from the customer (step 1006). For example, the customer may click a button on the web page or click on a hyperlink on the web page. If it is determined that the offer is not accepted (step 1008), then the transaction is processed conventionally (step 1010). For example, the items are purchased for the conventional total price, and a credit card account of the customer is charged appropriately.

If it is determined that the offer is accepted (step 1008), then the subsidy is applied to the items (step 1012) and the items are sold to the customer with the benefit of the subsidy (step 1014).

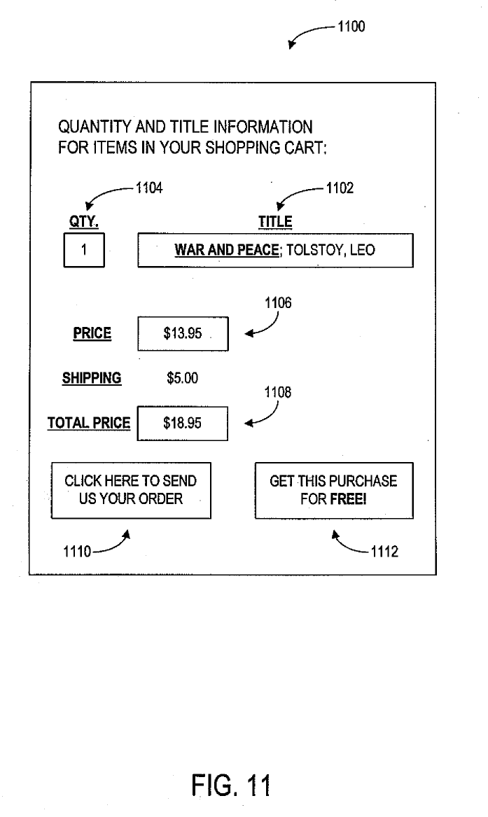

Referring to FIG. 11, an exemplary web page 1100 illustrates a possible means for providing an offer for a benefit and receiving an acceptance of the offer. The web page 1100 illustrates an embodiment in which the merchant sells books via the World Wide Web. A book that the customer is ready to purchase is indicated by text 1102, and a quantity of that book (one book in FIG. 11) is indicated by text 1104. A price of the books is indicated by text 1106, and similarly a total price (e.g. the sum of item prices and any other prices) due from the customer is indicated by text 1108.

A button 1110 is clicked by the customer if the customer desires to purchase the specified items and thereby consummate the purchase. Upon clicking the button 1110, the items may be immediately deemed as having been purchased by the customer. A button 1112 is clicked by the customer if the customer desires to accept an offer for a subsidy. Alternatively, actuating the button 1112 may indicate that the customer is interested in further information regarding an offer for a subsidy, and the customer may subsequently indicate whether he accepts the offer.

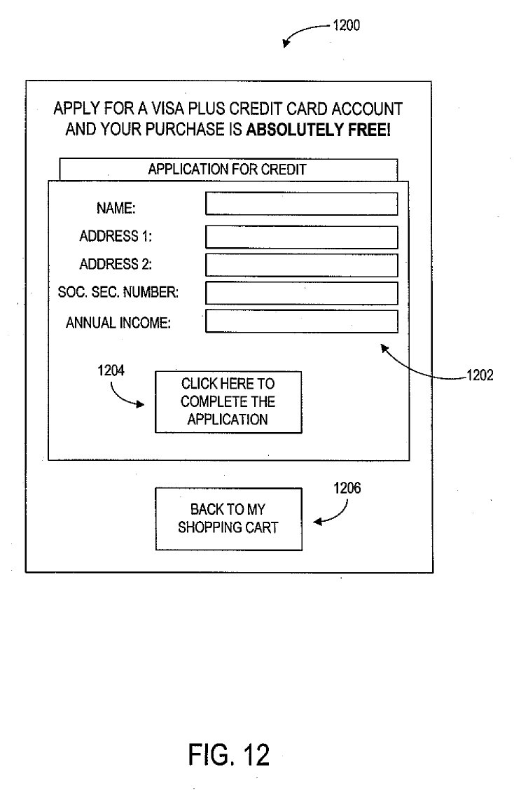

Referring to FIG. 12, a second exemplary web page 1200 allows the customer to provide customer information via a form having fields 1202 that receive entered text. The customer information is used in applying for a credit card account with a credit card issuer. In one embodiment, the web page 1200 may be displayed after the customer clicks the button 1110 of FIG. 11. Information that is entered via the web page 1200 may be transmitted to the merchant server 110 upon actuation of a button 1204. Actuation of the button 1204 may furthermore indicate acceptance of the offer for the subsidy. For example, actuation of the button 1204 may indicate a willingness to apply for a credit card account, or that the customer has applied for the credit card account. Conversely, actuation of the button 1206 may indicate rejection of the offer for the subsidy.

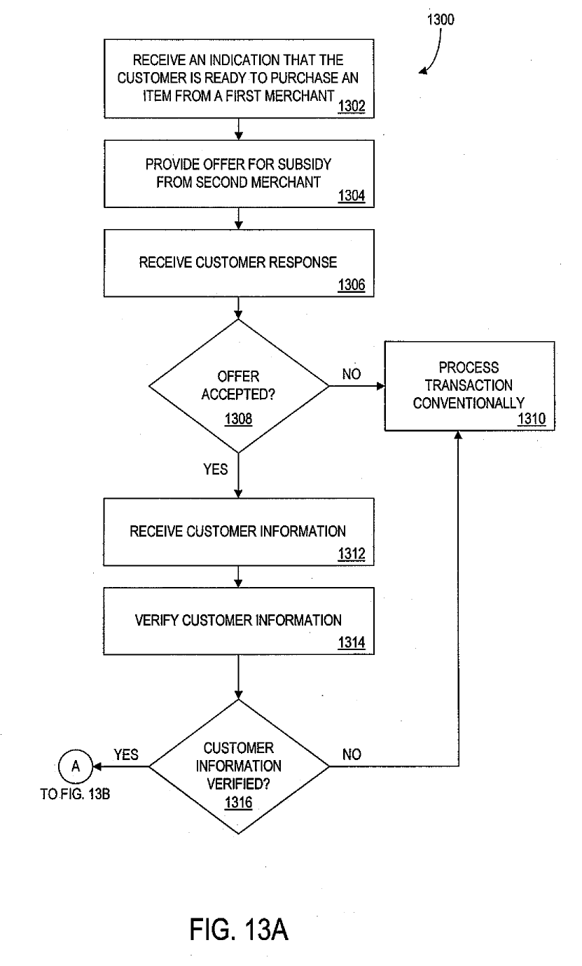

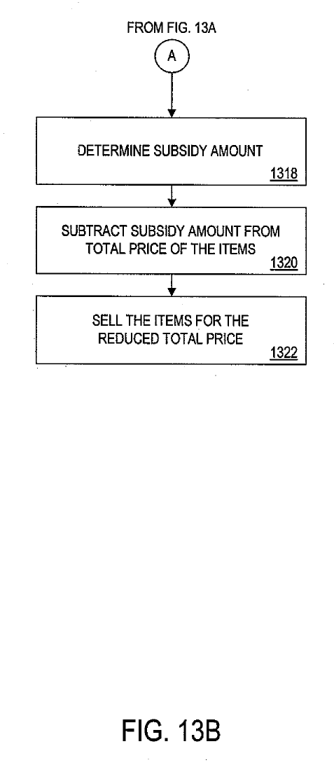

Referring to FIGS. 13A and 13B, a flow chart 1300 illustrates another embodiment of a method for providing an offer for a benefit to a customer that is to purchase items from a merchant. The merchant server 110 receives an indication that the customer is ready to purchase items from the web site of a first merchant (step 1302). A customer may indicate his readiness to purchase by, for example, selecting items to purchase and actuating a specific button that consummates the purchase of the items. Before the customer purchases the items, the merchant server 110 provides the customer with an offer for a subsidy from a second merchant (step 1304). Subsequently, a response from the customer is received (step 1306).

If it is determined that the offer is not accepted (step 1308), then the transaction is processed conventionally (step 1310). If however it is determined that the offer is accepted (step 1308), then customer information is received (step 1312). Such customer information may be used in providing or facilitating an additional transaction that is required of the customer in exchange for the subsidy. In one embodiment described in further detail below, in exchange for the subsidy the customer agrees to initiate a new service agreement, so that a service is provided by the second merchant. Accordingly, the customer information may comprise an indication of a service that is provided to the customer (e.g. whether the customer has cable television service), or a service provider that provides a service to the customer (e.g. which company provides cable television service to the customer). The additional transaction may occur after a significant amount of time has elapsed. Accordingly, in one embodiment there is a means for determining if the future action has occurred.

Furthermore, a penalty may be assessed against the customer if the customer does not perform the required additional transaction. For example, the subsidy to the customer may be canceled and the transaction may then be processed conventionally. Alternatively, a penalty fee may be charged to the customer.

Similarly, a penalty could be assessed if another imposed condition is violated. For example, a penalty could be assessed if the items are purchased and then returned. Accordingly, in such an embodiment a returnable purchase is made a non-returnable purchase in exchange for the subsidy or other benefit.

The customer information may be received from the customer. In one embodiment, the merchant server 110 can request that the customer provide customer information. For example, the merchant server 110 may transmit a form (e.g. via the web site) including questions to be answered. In response, the merchant server would receive answers to the questions, and these answers would constitute the customer information from the customer.

In another embodiment, the customer information may be received from a party other than the customer. For example, information regarding the customer may be received from a third-party database (e.g. a list of addresses to provide a location of the customer). Alternatively, customer information may be received from an ISP (Internet Service Provider), which can provide information such as an Internet address of the customer.

In still another embodiment, the customer information may be received via a “cookie” stored on the customer terminal 120 (FIG. 1). Those skilled in the art will understand that a great variety of data may be stored in such cookies, and information may be stored in the cookie in response to various events such as the web sites that are visited by the customer.

The merchant server 110 may verify whether the customer information is accurate (step 1314). For example, if the information is provided by the customer, it can be advantageous to assure that the customer information is not false. To provide a further incentive for the customer to provide accurate customer information, a penalty may be assessed against the customer if the customer information is not accurate. For example, if it is determined that the customer information is not accurate (step 1316), the subsidy to the customer may be canceled and the transaction is processed conventionally (step 1310). Alternatively, a penalty fee may be charged to the customer if it is determined that the customer information is not accurate. In such an embodiment, it may be further advantageous to verify the customer information before the purchase is consummated. Thus, the threat that the subsidy will not be forthcoming can give the customer an incentive to provide accurate information.

If it is determined that the customer information is accurate (step 1316), then the merchant server 110 determines the amount of the subsidy (step 1318). The subsidy amount is typically stored in the offer rules database 270 (FIG. 2). The subsidy amount may be, for example, a predetermined amount or a predetermined percentage (e.g. a predetermined percentage of the total price). The subsidy amount may also be limited, such that the price charged cannot be lower than zero. For example, a subsidy amount may be “up to $100 off, but no more than the total price”.

The subsidy amount is subtracted from the total price of the items (step 1320) and the items are sold for the reduced total price (step 1322). Alternatively, instead of the total price being reduced, a price of one or more items (e.g. items of a certain type or promotional items) may be reduced to provide an incentive to purchase these items. In summary, accepting the subsidy allows the items to be sold to the customer for a lesser price, and the items may even be provided to the customer without charge.

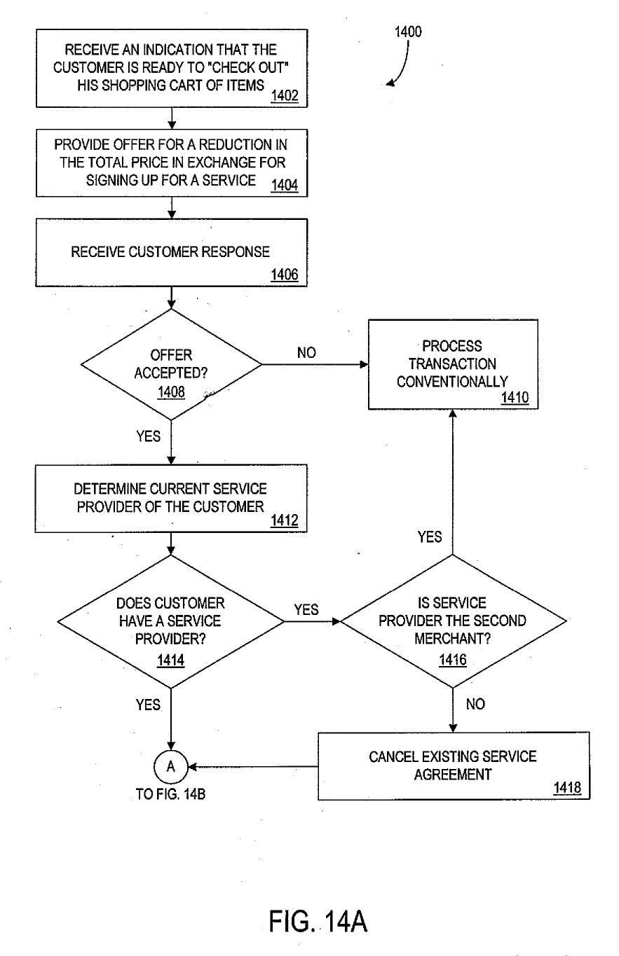

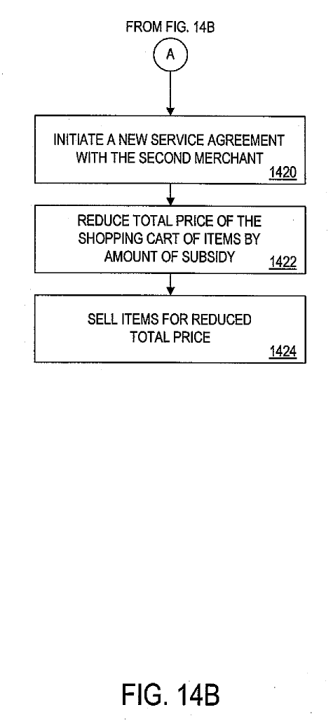

Referring to FIGS. 14A and 14B, a flow chart 1400 illustrates another embodiment of a method for providing an offer for a benefit to a customer that is to purchase items from a first merchant. The merchant server 110 receives a signal indicating that the customer is ready to “check out” his “shopping cart” of items on the web site of the first merchant (step 1402). As is understood by those skilled in the art, a shopping cart of items on a web site defines a set of items the customer desires to purchase. Checking out the shopping cart indicates a desire to proceed with purchasing the selected items.

Before the customer purchases the items, the merchant server 110 provides the customer with an offer for a reduction in the total price in exchange for signing up for a service with a second merchant (step 1404). For example, the service may be telephone service, Internet service, banking services, credit card account services, insurance service, securities trading service, satellite television service, or cable television service. Accordingly, the second merchant would be a provider of such services, and the customer would be requested to participate in a transaction (e.g. initiate a service agreement with) with the second merchant.

Subsequently, a response from the customer is received (step 1406). If it is determined that the offer is not accepted (step 1408), then the transaction is processed conventionally (step 1410). If however it is determined that the offer is accepted (step 1408), then a current service provider of the customer (i.e. a party that provides a specified service to the customer) is determined (step 1412). The customer may be asked to provide information of the current provider, or this information may be determined from other sources. For example, one or more databases may be accessed to determine the long distance telephone service provider of the customer. Alternatively, the second merchant may allow access to a database of its existing customers.

If it is determined that the customer has a service provider (step 1414), and it is determined that the second merchant already provides the customer with the specified service (step 1416), then the transaction is processed conventionally (step 1410). If it is determined that the customer has a service provider (step 1414), but it is determined that the second merchant does not provide the customer with the specified service (step 1416), then the customer must have a service agreement with another service provider. Accordingly, the existing service agreement is canceled (step 1418).

If it is determined that the customer does not have a service provider of the specified service at all (step 1414), (or if the merchant server 110 will cancel or has canceled the existing service agreement) then a new service agreement is initiated with the second merchant (step 1420). Thus, the second merchant has acquired a new customer, either by signing up the customer for a new service or by switching providers of the specified service that is provided to the customer. In exchange, the total price of the shopping cart of items is reduced by the amount of the subsidy (step 1422), and the items are sold for this reduced total price (step 1424).

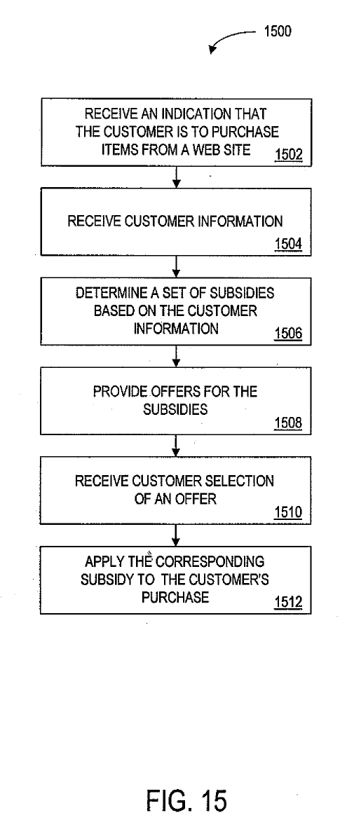

Referring to FIG. 15, a flow chart 1500 illustrates another embodiment of a method for providing an offer for a benefit to a customer that is to purchase items from a first merchant. The merchant server 110 receives an indication that the customer is ready to purchase items from the web site of a first merchant (step 1502). The merchant server 110 may also receive customer information (step 1504), as described above. The customer information may comprise, for example, a location of the customer or a current service provider of the customer.

A set of subsidies for which the customer may be eligible is determined (step 1506). In one embodiment, the set of subsidies is determined based on customer information. For example, upon reference to the customer information, one or more offer rules may be satisfied. The corresponding subsidies would then be included in the set of subsidies. In another embodiment, the offer rules may be satisfied without reference to customer information. For example, an offer rule may be satisfied if the total price of the items (or the price of any of the item) is greater than a predetermined threshold. In yet another embodiment, one or more subsidizing merchants may be contacted, customer information may be transmitted to the subsidizing merchants, and in response the subsidizing merchants may transmit to the merchant server 110 a description of a subsidy to offer.

Offers for each of the subsidies may be provided to the customer (step 1508) for the customer to select one (or more). For example, each offer may be listed on a web page, and the customer must click a hyperlink corresponding to his desired offer. The customer selection is received (step 1510) and the corresponding subsidy is applied to the customer's purchase (step 1512). Alternatively, the customer may be similarly prompted to select a merchant from a plurality of merchants, and the customer would subsequently be provided with an offer for a subsidy from the selected merchant.

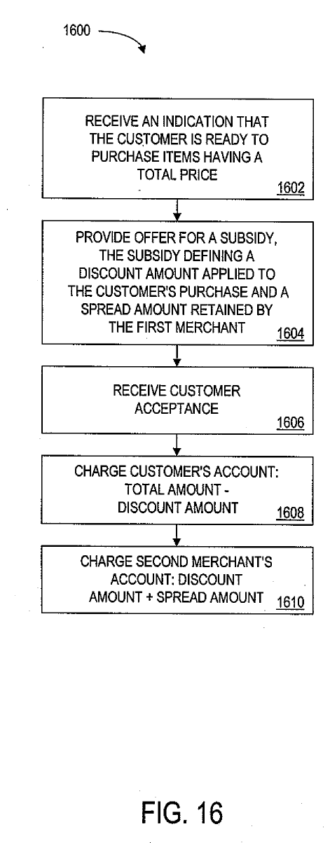

Referring to FIG. 16, a flow chart 1600 illustrates another embodiment of a method for providing an offer for a benefit. In particular, the illustrated flow chart 1600 shows the exchange of payment among the parties. The merchant server 110 receives an indication that the customer is ready to purchase items having a total price (step 1602). In response, the merchant server 110 provides an offer for a subsidy (step 1604). The subsidy defines a discount amount that is applied to the customer's purchase. The subsidy also defines a spread amount that is retained by the first merchant.

Once the customer acceptance is received (step 1606), the customer's account (e.g. a credit card account) is charged by the total amount less the discount amount (step 1608). Similarly, an account of the second merchant is charged by the sum of the discount amount and the spread amount. The second merchant may be charged substantially immediately (e.g. immediately after the customer accepts). In another embodiment, the customer may be charged at predefined intervals (e.g. once per month).

Although the present invention has been described with respect to a preferred embodiment thereof, those skilled in the art will note that various substitutions may be made to those embodiments described herein without departing from the spirit and scope of the present invention.

1. A method, comprising:
receiving an indication of at least one item that a customer is to purchase from a first merchant via a web site;
providing, in response to the received indication, an offer for a benefit from a second merchant, the step of providing the offer being performed before the at least one item is purchased;
receiving from the customer a response to the offer; and
applying the benefit to the at least one item if the response indicates acceptance of the offer.

2-64. (canceled)
